(19) United States
(12) Patent Application Publication
(10) Pub. No.: US 2025/0058511 A1
(43) Pub. Date: Feb. 20, 2025

(54) SYSTEMS AND METHODS FOR FORMING PIPING OR TUBING

(71) Applicant: RELIANCE WORLDWIDE CORPORATION (EUROPE), S.L., Granada (ES)

(72) Inventor: Juan Carlos MARTINEZ CASTAÑO, Granada (ES)

(21) Appl. No.: 18/723,887

(22) PCT Filed: Dec. 30, 2022
(86) PCT No.: PCT/IB2022/062923

§ 371 Date: Jun. 25, 2024

Related U.S. Application Data
(60) Provisional application No. 63/295,370, filed on Dec. 30, 2021.

(51) Int. Cl. B29C 48/90; B29C 48/00; B29C 48/09; B29C 48/92; B29K 23/00; B29L 23/00; C08F 8/00

(52) U.S. Cl. CPC B29C 48/903; B29C 48/022; B29C 48/09; B29C 48/906; B29C 48/92; C08F 8/00; B29K 2023/0691; B29L 2023/22; C08F 2810/20

(57) ABSTRACT

A system for preparing a cross-linked polyethylene a (PEX-a) pipe. The system includes a heating device with a chamber having a central axis, an inlet, and an outlet; oscillating infrared (IR) lamps and a water-cooling apparatus for cooling the temperature in the chamber, and a controller having a program code for regulating oscillation of the IR lamp, an extruder for conveying a cross-linkable feedstock into the chamber, and a pipe head for forming the PEX-a pipe.

### PRIORITY CLAIM

This patent application claims priority to U.S. Provisional Patent Application No. 63/295,370, filed Dec. 30, 2021, the disclosure of which is incorporated herein by reference in its entirety.

### TECHNICAL FIELD

The present disclosure relates generally to a system and method of making plastic pipes using a cross-linked polyethylene, specifically to PEX-a process in which the crosslinking is induced by peroxide under the influence of heat and high pressure.

### BACKGROUND

Extruded plastic pipe or tubing is well known and can be used for a variety of applications. Examples of materials used for manufacturing plastic piping can include polyolefins such as polyethylene (PE) (e.g., PE-raised temperature, or PE-RT), polypropylene (PP), polybutylenes (PB), and any copolymers thereof; polyolefin copolymers such as poly (ethylene-co-maleic anhydride); poly (vinyl chloride) (PVC); and chlorinated PVC, i.e., CPVC; etc.

In certain examples, a cross-linked polymer, such as cross-linked polyethylene (PEX), may be used for making plastic pipes. PEX-a, PEX-b, and PEX-c are known varieties of PEX for making plastic pipe. When manufacturing PEX-a, crosslinking is induced by peroxide under heat and pressure. The PEX-a composition is crosslinked through carbon-carbon bonds to form a crosslinked polymer network. The PEX-a crosslinking process occurs in a melted stage, as opposed to the primary crosslinking processes for PEX-b and PEX-c.

There is a need for a more improved process for manufacturing a PEX-a pipe or tube that results in less waste and energy while increasing output.

### SUMMARY

The present disclosure relates to a method and system of manufacturing PEX-a plastic pipe or tube. The pipes can be used in both cold and hot water applications. PEX-a is produced by a peroxide (Engel) method. This method performs “hot” cross-linking, above the crystal melting point. The “Engel” or peroxide method employs a special extruder with a plunger action where peroxide is added to the base resin and through a combination of pressure and high temperature the cross-linking takes place as the tubing is produced.

The present disclosure relates to a system and method of making a PEX-a pipe or tube that utilizes an infrared oven and a water-cooling apparatus. In the PEX-a process, the primary reaction is the formation of free radicals upon decomposition of the peroxide. The free radical abstracts hydrogens from the PE polymer chains which give new carbon radicals that combine with neighboring PE chains to form stable carbon-carbon bonds, i.e., crosslinks. The crosslinking is homogeneous and uniform and gives degrees of crosslinking above 70%.

One aspect of the present disclosure relates to a system for preparing a cross-linked polyethylene a (PEX-a) pipe. The system can include a heating device that includes a chamber with a central axis, an inlet, and an outlet. A plurality of oscillating infrared (IR) lamps may be in the heating device along with a water-cooling apparatus for cooling the temperature in the chamber. The term “oscillating” refers to turning the IR lamp on and off, for example, over defined intervals of time. The combination of a multiplicity of IR lamps and water-cooling offers good temperature control within the infrared oven chamber and good ability to control the extent of cross-linking. The system also includes a controller comprising a program code for regulating oscillation of the IR lamp; an extruder for conveying a cross-linkable feedstock into the chamber; and a pipe head for forming the PEX-a pipe.

Another aspect of the present disclosure relates to a method of making a PEX-a pipe. The method includes the steps of feeding a cross-linkable feedstock into a process system to form a cross-linkable pipe, and exposing the cross-linkable pipe to oscillating infrared lamps in a chamber of an infrared oven to form the cross-linked polyethylene pipe.

These and other features and advantages will be apparent from a reading of the following detailed description and a review of the associated drawings. A variety of additional aspects will be set forth in the description that follows. The aspects can relate to individual features and to combinations of features. It is to be understood that both the foregoing general description and the following detailed description are exemplary and explanatory only and are not restrictive of the broad concepts upon which the examples disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a block diagram of a PEX process including infrared ovens, an extruder, a pipe head, a master wheel, vacuum and cooling tank in accordance with principles of the present disclosure;

FIGS. 2-4 illustrate multiple views of an example vertical assembly for processing PEX-a material;

FIG. 5 illustrates a schematic view of the assembly;

FIG. 6 illustrates a schematic view of an example haul-off in accordance with the principles of the present disclosure;

FIGS. 7-8 illustrate multiple views of the assembly of FIG. 5 showing the process of making a PEX-a pipe or tube in accordance with the principles of the present disclosure;

FIG. 9 illustrates an enlarged view of a portion of the master wheel of FIG. 1;

FIGS. 10-11 illustrate multiple views of the infrared ovens in an open position;

FIGS. 12 and 13 illustrate an assembly line in accordance with the principles of the present disclosure that includes the assembly of FIG. 5;

FIGS. 14 and 15 illustrate an example pipe head and housing in accordance with the principles of the present disclosure;

FIGS. 16 and 17 illustrate the pipe head and housing mounted to the extruder;

FIG. 18 illustrates a schematic view of the infrared oven;

FIG. 19 illustrates a schematic cross-sectional view of the infrared oven; and

FIGS. 20-22 illustrate various configurations of the pipe head and housing in accordance with the principles of the present disclosure.

### DETAILED DESCRIPTION

The present disclosure relates to systems and methods of making a uniform cross-linked polyethylene pipe or tube. The systems and methods described herein are generally in reference to making a PEX-a pipe, although various aspects of the process may be used in making PEX-b and PEX-c piping or tubing.

The advantageous features of a PEX-a material include the flexibility that the PEX-a material provides. The PEX-a material has a smaller bend radius compared to the PEX-b or PEX-c material. PEX-a material also has an elastic memory so it can be expanded to use expansion fittings. That is, a PEX-a pipe can be expanded and then shrink back around the fitting to provide a tight seal. PEX-a will return to its original shape in which it was extruded. If a kink is created in a PEX-a pipe, a heat gun can be used to heat the pipe or tube to return the pipe/tube to its original shape. Secondary processes further are not needed to crosslink the PEX-a after extrusion.

In an embodiment, the present disclosure is directed to a new process and system for manufacturing PEXa pipe. The system includes a heating device (e.g., an oven) that is designed with an Infrared (IR) Lamp and a water cooling apparatus. The heating device further includes a control that modifies or modulates the IR lamp. In particular, the IR lamp can be oscillated, e.g., turned on and off, according to a prescribed sequence that provides several benefits. The sequence of the IR lamps can be controlled at an optimum frequency and efficiency via software code to achieve a more stable process that yields consistent and uniform cross-linking.

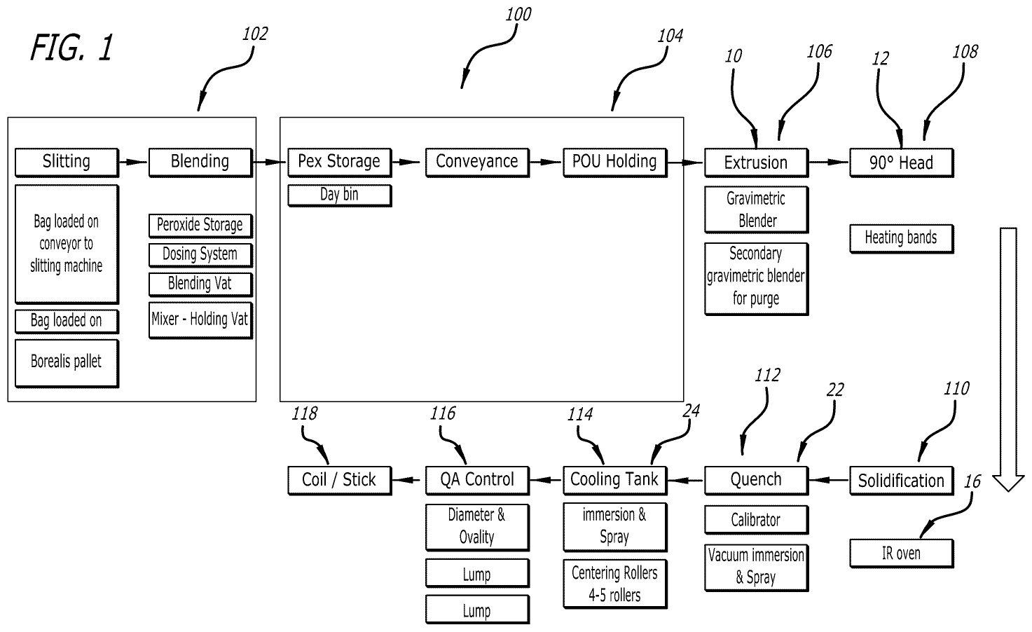

FIG. 1 is a block diagram of a PEX process 100. In the example depicted, the process is specific to PEX-a, but aspects of the disclosure may also be applicable to PEX-b and PEX-c. Each of the steps in the process 100 will now be described.

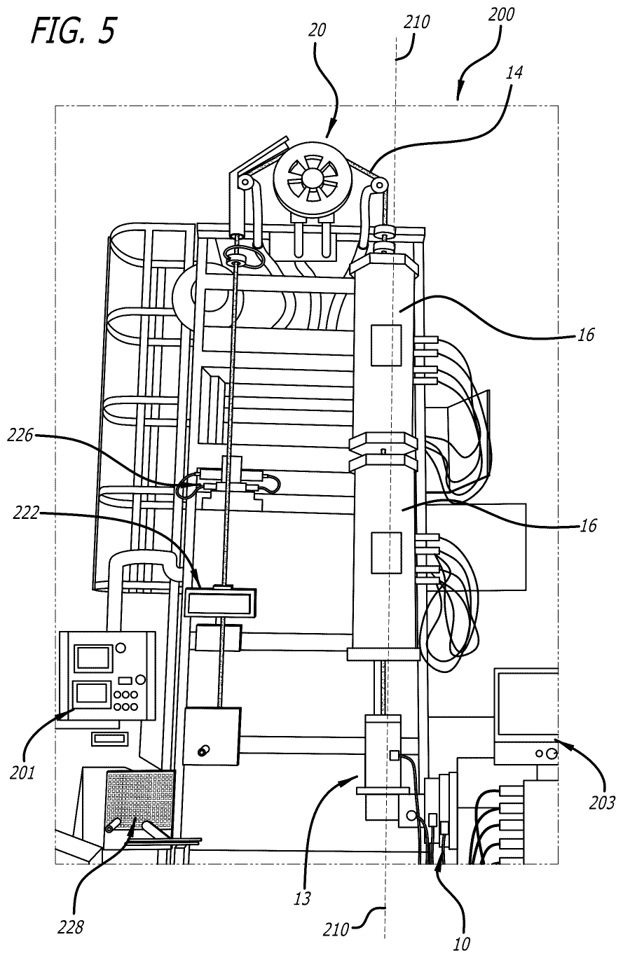

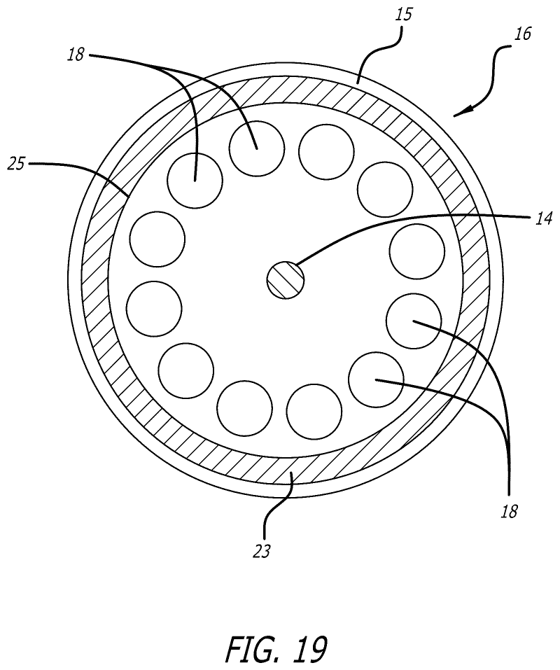

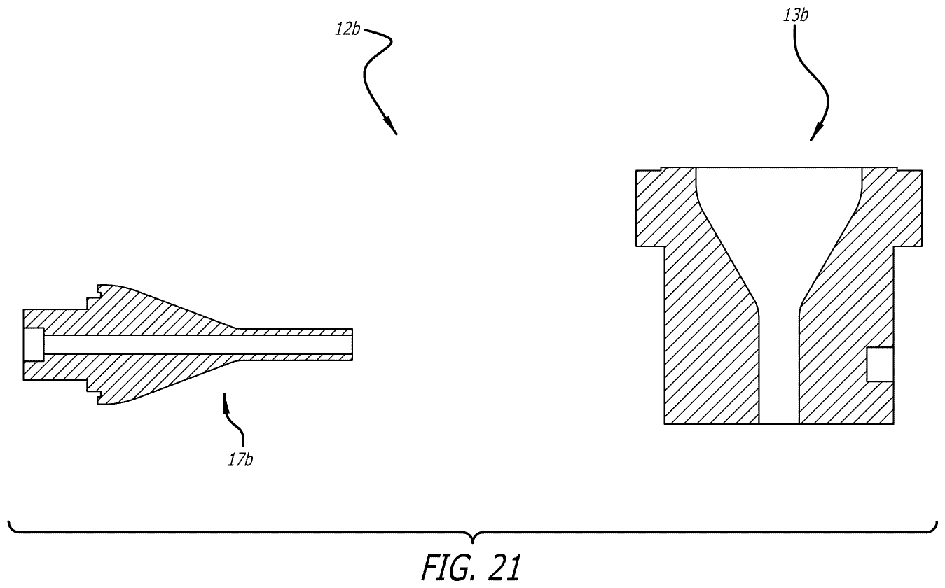

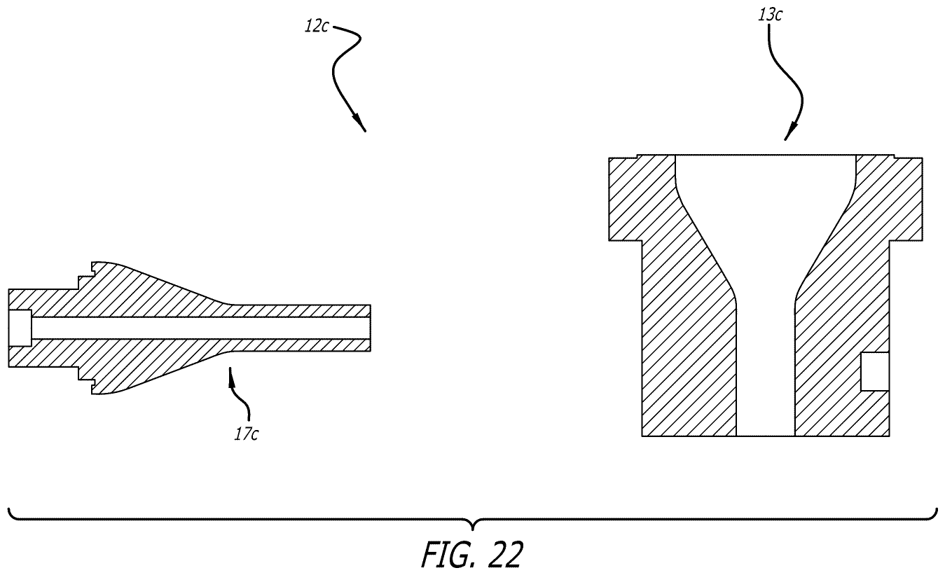

In step 102, a feedstock comprising polymer pellets and peroxide can be blended in a tank and stored and/or conveyed in step 104. A gravimetric blender may be used to blend peroxides and other polymer resins that are fed into an extruder 10 at step 106. The material resin passes into a pipe head 12 at step 108 to form a pipe 14 (e.g., tube) (see FIG. 5). Details of the pipe head 12 will be described in more detail with reference to FIGS. 19-22.

At step 110, the pipe 14 passes through a heating device 16 such as an oven with multiple infrared (IR) lamps 18 and is exposed to the multiple IR lamps 18 (see FIG. 23). The IR lamps 18 can provide consistent and stable heating of the pipe 14. The pipe 14 is solidified or fully cross-linked once it leaves the infrared oven 16. After the pipe 14 leaves the infrared oven 16, the pipe 14 passes through a vacuum 22 (e.g., quench) and a chilled water tank 24 where the dimensions of the pipe 14 are then set. That is, the pipe 14 can be quenched at step 112 and immersed in a water bath 26 of the chilled water tank 24 at step 114. The pipe 14 can be inspected for quality control at step 116 to ensure final properties of the pipe 14 are within specification. The pipe 14 can be coiled at step 118 and prepared for storage and/or shipment.

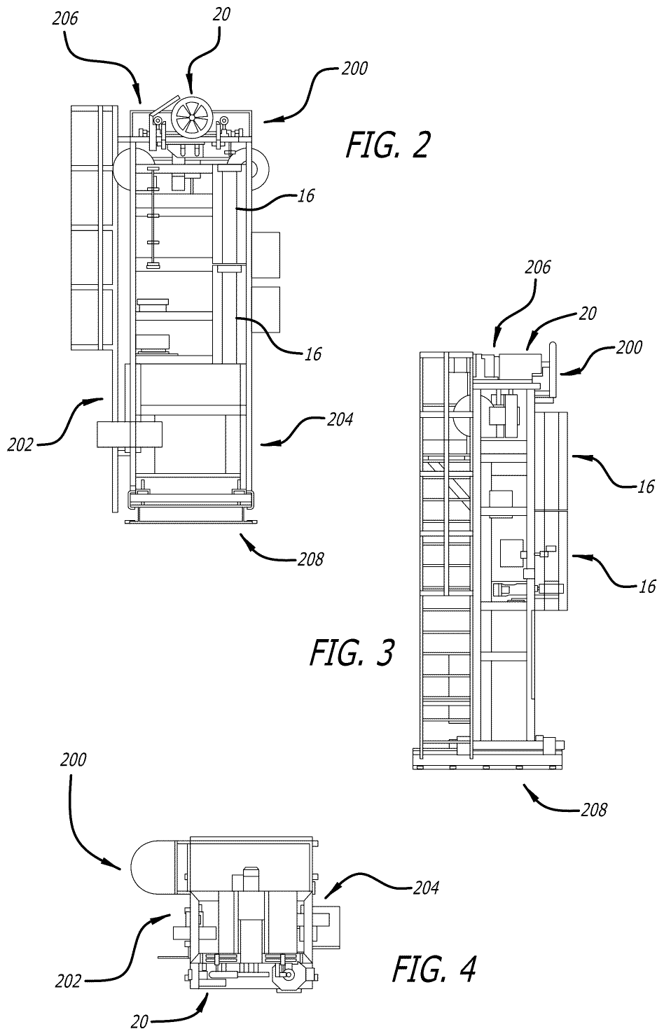

FIGS. 2-4 are schematic views of a vertical assembly 200 as part of the PEX process 100. The assembly 200 has a first side 202 (e.g., a left side), a second side 204 (e.g., a right side) positioned opposite the first side 202, a top side 206, and an opposite, bottom side 208. Although a vertical assembly is depicted, it will be appreciated that the assembly may also be configured horizontally.

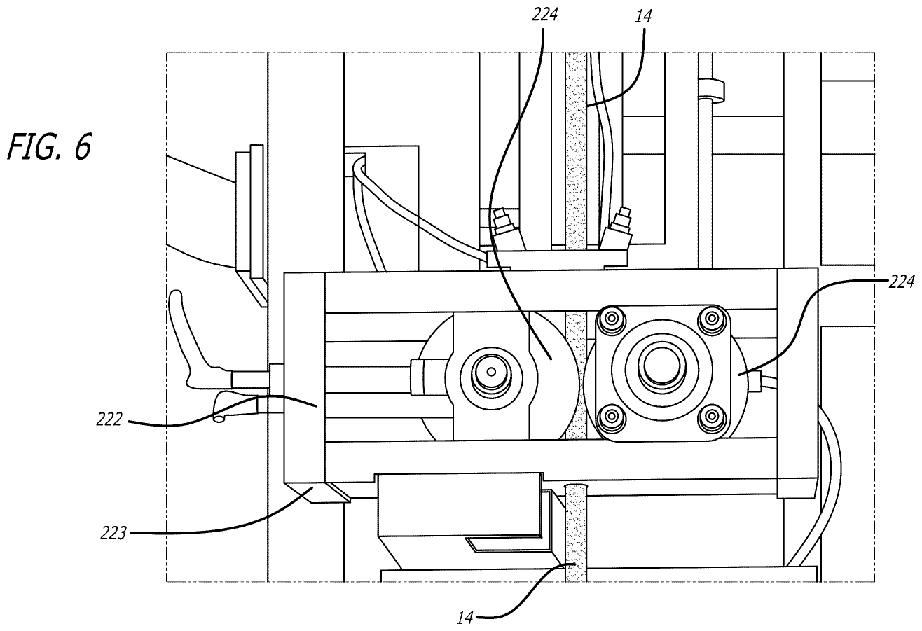

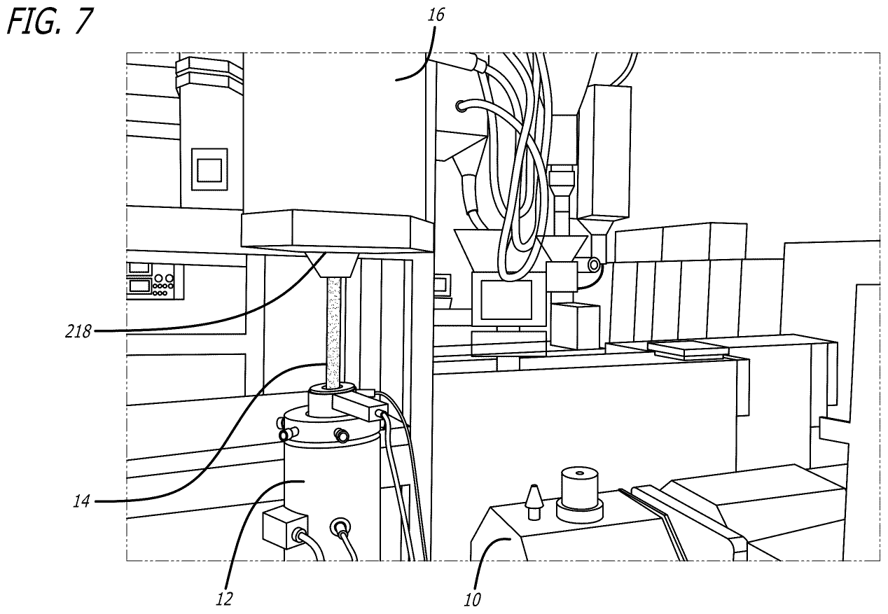

FIGS. 5-6 illustrate the assembly 200 including the extruder 10, a master wheel 20 and the pipe head 12. The pipe head 12 has a center axis 210 in alignment with the infrared ovens 16 and is perpendicular to the extruder 10. That is, the pipe head 12 is positioned about 90 degrees relative to the extruder 10 such that the PEX-a material or pipe 14 traveling out of the extruder 10 turns 90 degrees into the pipe head 12.

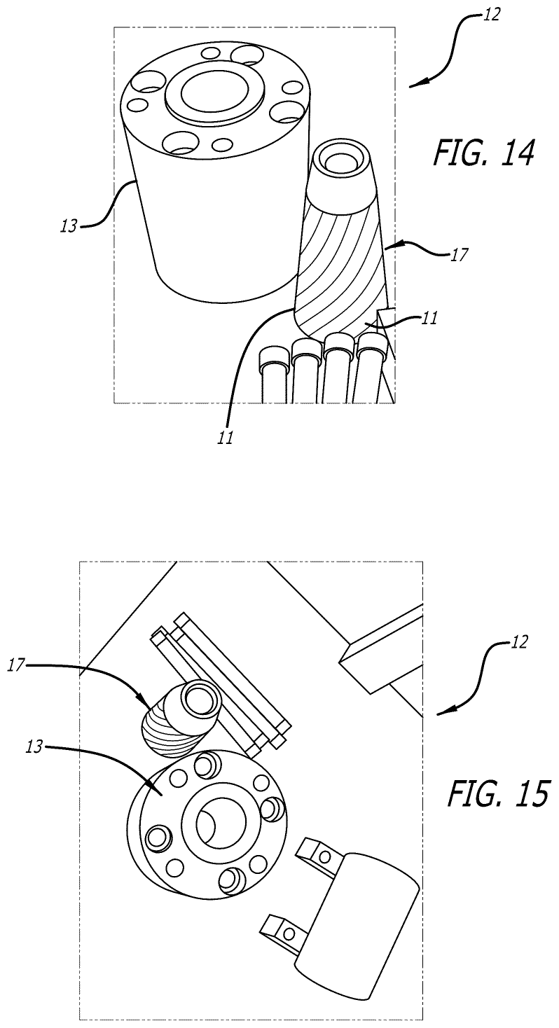

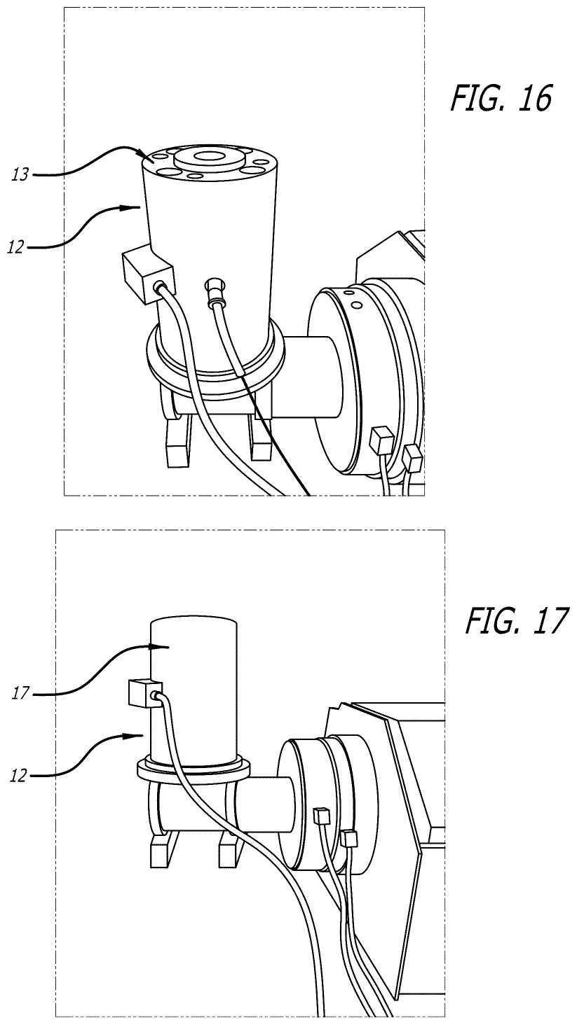

FIGS. 14-15 show the pipe head 12 disassembled to depict an internal component 17 with rifling features 11 or other helical projections and a housing member 13 (e.g., casing) that houses the internal component 17. The rifling features 11 help to facilitate constant movement of the pipe material. This is advantageous in reducing buildup of pipe material by products that can inhibit the flow of pipe material through the pipe head 12. FIGS. 16-17 show the pipe head 12 mounted in the assembly 200. For illustrative purposes, the internal component 17 is shown in hidden lines in FIG. 17.

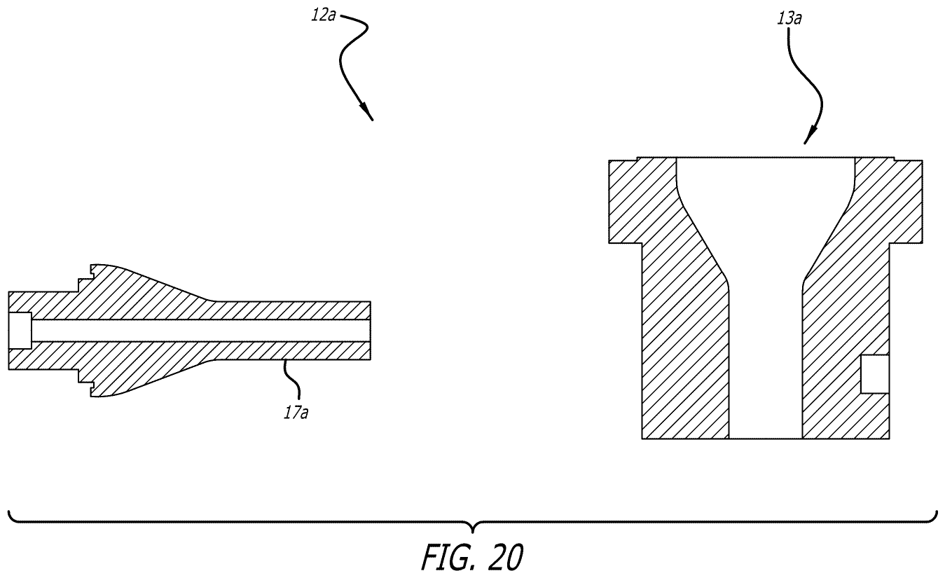

The pipe head 12 can creates a shape, a size, wall thickness of the pipe 14. FIGS. 20-22 illustrate various pipe head 12 and housing member 13 configurations for making 1 inch, ½ inch or ¾ inch pipe 14, respectively. As such, the pipe 14 can have a variety of sizes. In certain cases, the pipe 14 outer diameter can be anywhere between ⅜ inch to 2 inches, although alternatives are possible. The pipe 14 outside diameter is not limited in size but can also be 3 inches, 4 inches, 6 inches, etc. The wall thickness will thus vary with the outer diameter of the pipe 14.

The pipe head 12 may be a 90-degree pipe head such that the material from the pipe head 12 turns 90-degrees toward an infrared oven 16 at step 110. Heating bands within the pipe head 12 allow the melt pressure of the material passing therethrough more stable. In certain examples, the housing member 13 of the pipe head 12 can be mounted relative to the extruder 10. The pipe head 12 can include a single opening provided at an internal joint between the extruder 10 and the pipe head 12.

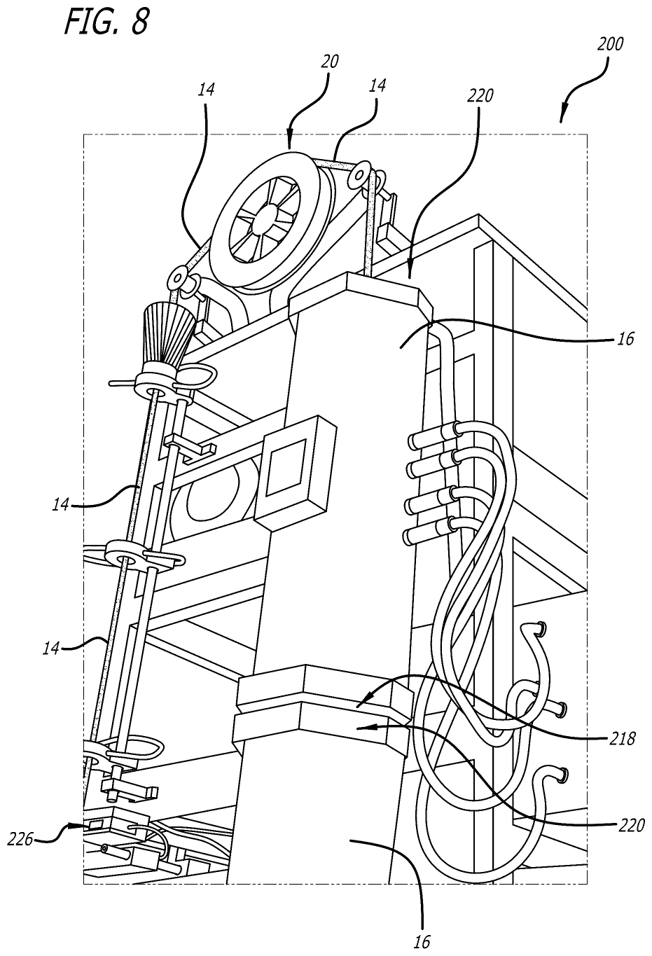

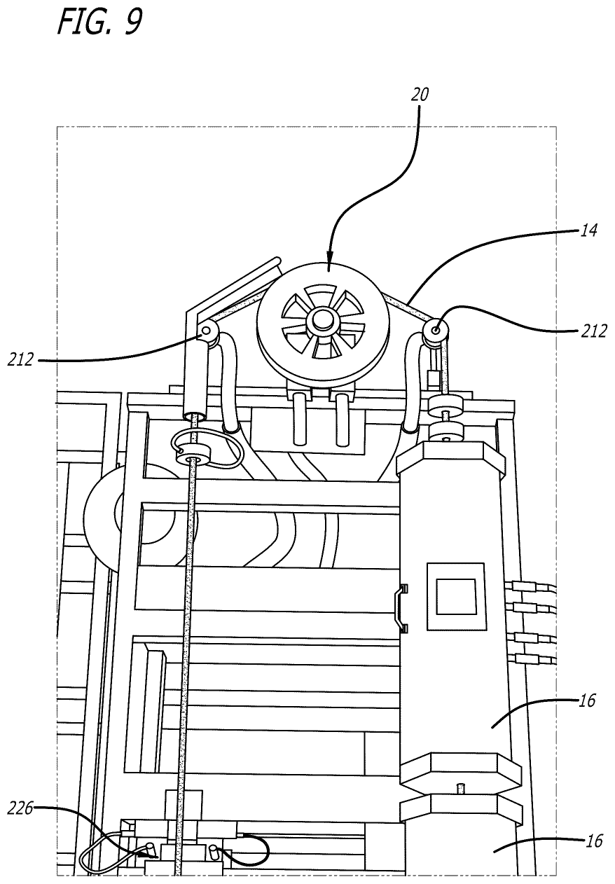

FIGS. 8-9 illustrate the PEX-a pipe 14 as it travels through the assembly 200. For example, the pipe 14 is shown being extruded out of the extruder 10. and travelling through the pipe head 12 into the infrared ovens 16. The pipe 14 can also travel along a master wheel 20 and through a series of rollers 212. The master wheel 20 (see FIG. 2) can be positioned directly adjacent to and outside of the infrared oven 16. The master wheel 20 can be designed to be positioned closely to the infrared oven 16 rather than at an end of the process line. The master wheel 20 is driven and can be used to help pull the pipe 14 directly out of the infrared oven 16. Having the master wheel 20 positioned after the infrared oven 16 provides less stretch and change in the dimensions of the pipe 14. That is, the advantageous feature of having the master wheel 20 closer to the oven 16 allows for less change and movement in the pipe 14 which typically occurs when there is a long process line.

The master wheel 20 is shown at the top side 206 of the assembly 200 directly adjacent the infrared ovens 16 to control the speed of the pipe 14 through the infrared ovens 16. The master wheel 20 can control the speed by which the pipe 14 travels through the infrared oven 16 to help provide uniform and consistent dimensions (e.g., outside diameter) of the pipe 14. Because the pipe 14 is fully crosslinked upon exiting the infrared oven 16, the pipe 14 can be more stable which results in a more consistent dimension that is within ±0.1. Also, the elasticity of the pipe 14 can be more consistent through the infrared oven 16.

The assembly 200 also includes a haul-off 222 (see FIG. 6) in close proximity to the infrared ovens 16. The haul-off 222 includes a frame 223 and two inwardly turning or opposing cylinders 224 (i.e., rollers) driven by an electric motor or other suitable actuator to engage and pull the pipe 14. The haul-off 222 controls the velocity of the pipe 14 moving through the assembly 200. That is, the haul-off 222 is configured to control the speed of the pipe 14 moving through the infrared ovens 16. The speed of the haul-off 222 can be set relative to the master wheel 20 to control stretch of the pipe 14 moving through the system. The haul-off 222 controls the speed to synchronize with the master wheel 20 to control the dimensions and tension in the pipe 14 passing through the assembly 200.

In certain examples, the assembly 200 may include programmable logic controllers 201, 203 (e.g., control system, CPU, processor, etc.) (see FIG. 5). The programmable logic controllers 201, 203 may be configured to execute a software program to control the operations of the assembly 200. For example, the programmable logic controllers 201, 203 may be configured to control both the haul-off 222 and the master wheel 20, although alternatives are possible.

In certain examples, the haul-off 222 may operate slightly faster than the master wheel 20 to control tension in the pipe 14 and to induce a small amount of required stretch in the pipe 14. The haul-off 222 may also operate to control dimensions of the pipe, such as pipe diameter. In some examples, the haul-off 222 may operate generally at similar speeds as the master wheel 20. The speeds of the haul-off 222 and the master wheel 20 will vary based on the size of the pipe 14. Similar to the master wheel 20, the haul-off device can positioned closer to the infrared ovens 16 rather than at the end of the assembly 200 to reduce stretch and change in the pipe 14. A dancer 228 (see FIG. 5) may be used to control line speed of the assembly 200. In certain examples, the dancer 224 may be used to synchronize a caterpillar device at the end of the assembly 200.

The assembly 200 may also include a sensor 226 such as a laser micrometer to measure an outer diameter of the pipe 14. The sensor 226 is designed to read out the outer diameter of the pipe 14. If the outer diameter is out of specification, the read out by the sensor 226 would prompt a user to make manual adjustments to the speed to achieve the desired outer diameter of the pipe 14. In other examples, the sensor 226 may be automatically controlled to adjust the haul-off 222 to update the line speed to achieve the outer diameter.

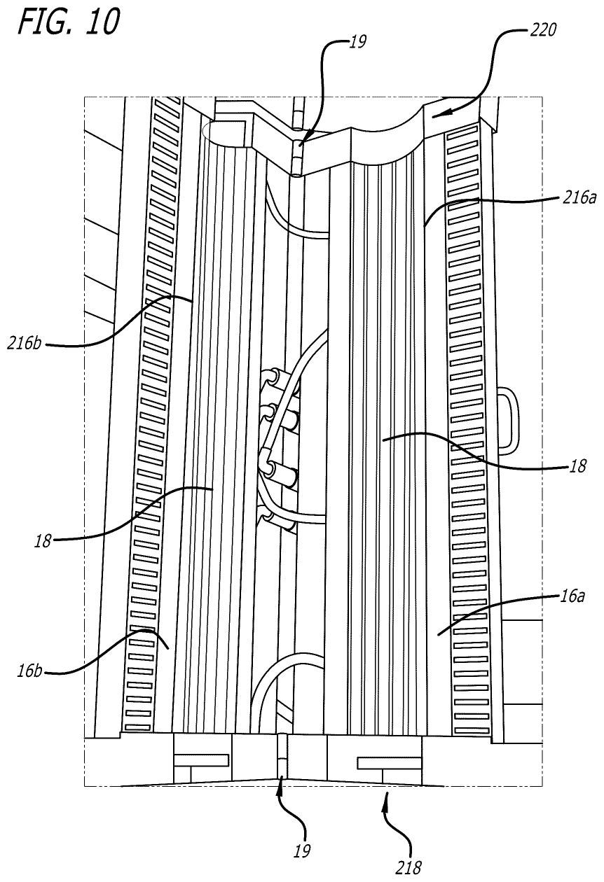

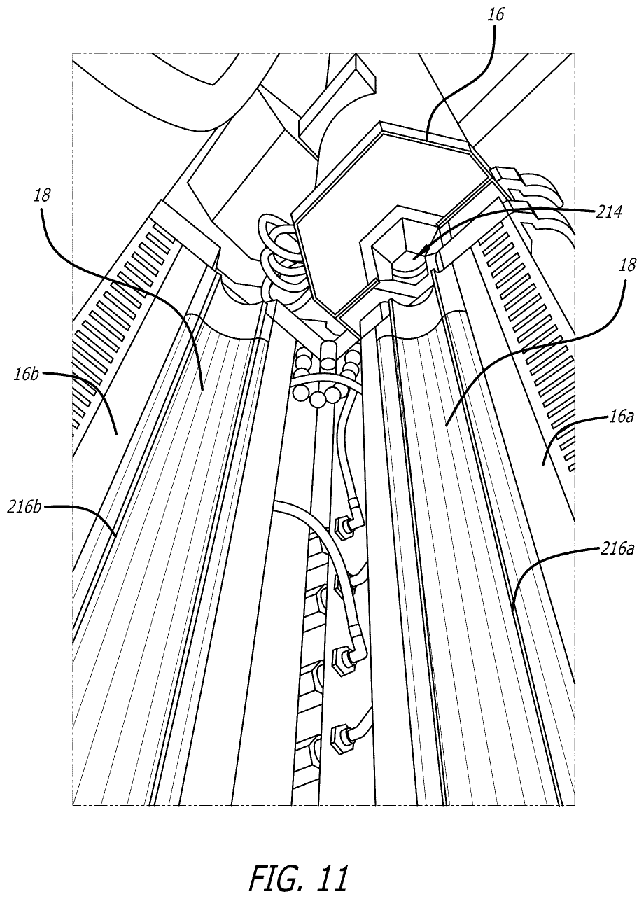

Referring to FIGS. 10-11, the assembly 200 is depicted with two infrared ovens 16 vertically positioned relative to one another at the second side 204 of the assembly 200, although the infrared ovens 16 may also be configured horizontally. It will be appreciated that the infrared ovens 16 may be positioned at the first side 202 of the assembly 200. It will be appreciated that the number of infrared ovens 16 may vary to increase operational speed of the assembly 200.

The infrared ovens 16 define an opening 214 along the central axis 210 for passing the pipe 14 therethrough. The two hemispherical portions 16a, 16b of the infrared ovens 16 can each include an inner casing 216a, 216b through which the pipe 14 travels. The infrared ovens 16 can each include an inlet end 218 and an outlet end 220.

The pipe 14 can pass between the IR lamps 18 to be exposed thereto. That is, the pipe 14 travels generally through the center of the IR lamps 18 for more consistent heat application. The IR lamps 18 can be positioned in the infrared oven 16 to heat the full circumference of the pipe 14 to provide uniform and consistent heating that achieves a more stable and uniform cross-linking process. That is, the configuration of the IR lamps 18 provide 360 degree heating around the full circumference of the pipe 14 to provide optimal coverage. The infrared oven 16 provides more heat intensity that allows for more efficient heating and less heating time. As such, the line speed can be increased and the infrared oven 16 can be shorter. For example, the oven 16 can have a reduced length of 2 m, compared to ovens that are 8 m or more in length. The line speed may be increased to at least 20 m/min, or at least 25 m/min, or about 30 m/min yielding greater outputs compared to 17 m/min for an IR system that does not oscillate the IP lamp and uses air cooling rather than water cooling.

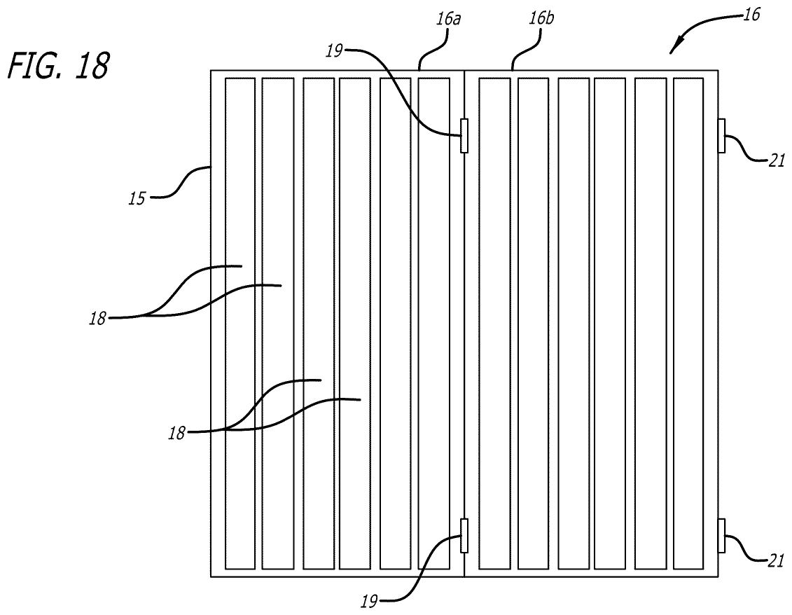

FIG. 18 is a schematic of one of the infrared oven 16 in an open position. The infrared oven 16 includes an oven casing or housing 15 with two hemispherical portions or halves 16a, 16b that are connected at hinges 19 to allow for opening and closing of the oven housing 15 for maintenance, such as, IR lamp replacement. The two hemispherical portions 16a, 16b can be locked together via a locking mechanism 21. When in the closed position, the two hemispherical portions 16a, 16b can be brought into abutment with each other and joined together and locked by the locking mechanism 21.

It will be appreciated that the halves 16a, 16b of the infrared oven 16 may also have a polygonal shape, although alternatives are possible.

At least six IR lamps can be positioned on each one of the hemispherical portions 16a, 16b. As such, a total of 12 IR lamps can be positioned within the infrared oven 16, although alternatives are possible. In certain examples, a total of 18 IR lamps may be positioned within the infrared oven 16. As such, 9 IR lamps may be positioned in each one of the hemispherical portions 16a, 16b. When manufacturing a PEX pipe that has about a 1-inch diameter, 12 total IR lamps may be used. When manufacturing a PEX pipe of greater size, such as 1¼ inch pipe, 18 total IR lamps may be used. In other examples, the infrared oven 16 can include between 12-18 sets of IR lamps 18 that extend the full length of the infrared oven 16. In certain examples, the infrared oven 16 may be vertically positioned, but may also be horizontally positioned. If larger diameter pipe 14 is made, the horizontal configuration may be preferred.

FIG. 19 is a cross-sectional view of the infrared oven 16. The IR lamps 18 are shown circumferentially surrounding the pipe 14 passing through the infrared oven 16. Due to the heater design, a full 360 application of heat can be provided.

The infrared oven 16 also includes a cooling fluid chamber 23 in which cooling fluid is designed to be circulated therethrough. Fluid can pass through the cooling fluid chamber 23 from a fluid source using a pump or circulation device and a controller. The IR lamps 18 within the infrared oven 16 can be liquid cooled by fluid circulated through the cooling fluid chamber 23. Furthermore, the temperature in the infrared oven 16 may be cooled rather than using air to create a more stable process. That is, because air circulation through the heater can cause the pipe material to sway or move, there can be an uneven application of heat. The advantages of using liquid cooling allows the pipe material to remain generally at a constant position in relation to the IR lamps. As such, using liquid cooling helps to maintain good environmental conditions, (e.g., no disruptive air flow) which facilitates a more even application of heat and thus a more reliable and uniform cross-linking can be achieved. The oven design and the cooling fluid chamber 23 together help to provide uniform cross-linking in the pipe 14 to yield better control in achieving a uniform outside diameter and wall thickness.

In certain examples, the cooling fluid chamber 23 may include a cooled water or fluid tank, although alternatives are possible.

The infrared oven 16 can further include a reflective inner wall/surface 25. In certain examples, the reflective inner wall/surface 25 can include a metallic material such as stainless steel, although alternatives are possible. In other examples, other composites and/or synthetic reflective materials may be used.

By replacing the air with chilled water inside the infrared oven 16 of the PEX-a process 100, the pipe 14 can remain steady while passing through the infrared oven 16. Also, by removing air from the infrared oven 16, energy used to control the crosslinking is much more consistent throughout the entire PEX process.

In certain examples, a controller, such as the programmable logic controllers 201, 203 can include a program code for regulating oscillation of the IR lamp. That is, software may be implanted in the process to control the infrared oven 16 to oscillate the IR lamps 18. The oscillation process help to provide the desired properties of the pipe 14 that yield uniform cross-linking and dimensions.

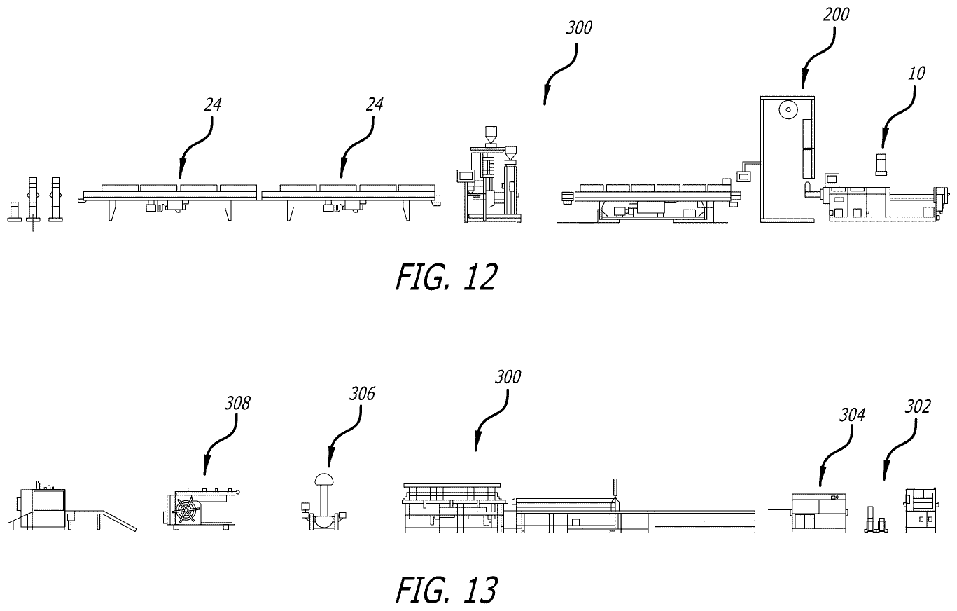

FIGS. 12 and 13 illustrate an assembly line 300 that includes the assembly 200. The assembly line 300 can also include a printer 302 for labeling functionality, a cutting assembly 304 to cut the pipe 14, a pipe accumulator 306 and automatic coiler 308.

FIGS. 20-22 show various cross-sectional views of pipe heads according to embodiments of the present disclosure.

### Definitions

The singular forms “a”, “an” and “the” are intended to include the plural forms as well, unless the context clearly indicates otherwise.

The term “and/or” refers to and encompasses any and all possible combinations of one or more of the associated listed items.

The term “about,” when referring to a measurable value such as an amount of a compound, dose, time, temperature, and the like, is meant to encompass variations of 10%, 5%, 1%, 0.5%, or even 0.1% of the specified amount.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs. In the event of conflicting terminology, the present specification is controlling.

All patents, patent applications and publications referred to herein are incorporated by reference in their entirety.

### Materials

### Polymers

The cross-linkable feedstock for making the polymeric pipes of the disclosure include a polyethylene, such as a high-density polyethylene (HDPE). Polyethylene (PE) is classified into several different categories based mostly on its density and branching. The final product performance and mechanical properties depend significantly on variables such as the extent and type of branching, the crystallinity, the density, and the molecular weight and its distribution. PEX pipes are commonly manufactured from high density polyethylene (HDPE), however, the present disclosure may include a cross-linkable feedstock or a coating composition that may comprise any type of polyolefin or polyethylene is used for the production of single-layer or multi-layer plastic pipes such as, but not limited to, low density polyethylene (LDPE), medium density polyethylene (MDPE), PE 100, PE 80, PE-RT grades, and ultra-high molecular weight polyethylene (UHMWPE) or combinations thereof.

Examples of commercially available HDPE that may be used in pipes of the present disclosure include Borealis HE1878E; Borealis HE1878E-C2; HE1878; Borealis HE2550, each available from Borealis AG, Vienna, Austria; Lupolen 5261Z Q456; Lyondellbasell, Basell Q 456, Basell Q 456B, Basell New Resin, Basell Q 471, (LyondellBasell Company, Clinton Iowa, United States).

### Peroxides

The cross-linkable feedstock of the present disclosure comprises a peroxide. The peroxide may be an organic peroxide. The peroxide may be any appropriate organic peroxide for crosslinking polyolefins. The organic peroxide may be a bi-functional peroxide used for crosslinking of polyolefins.

The organic peroxide may be 2,5-dimethyl-2,5-di(tert-butylperoxy)hexyne-3, for example, available as 85% solution in mineral oil in liquid form commercially available as, for example, Trigonox 145-E85; 3,3,5,7,7-pentamethyl-1,2,4-trioxepane commercially available as Trigonox 311; 2,5-dimethyl-2,5-di(tert-butylperoxy)hexane commercially available as Trigonox 101; each available from Nouryon Functional Chemicals B. V., Radnor, PA. The organic peroxide may be a di-tert-butyl peroxide. The peroxide may be present in the feedstock in from 0.1 to 2 wt %, or 0.5 to 1.0 wt %.

The cross-linkable feedstock compositions according to the disclosure may optionally contain one or more additional additives such as stabilizers, coagents, antioxidants, antimicrobial agents, and pigments.

### Coagents

The cross-linkable feedstock for making the polymeric pipes of the disclosure may optionally comprise a co-agent, for example one or more co-agents. The co-agents (monomers and/or oligomers) that may be used in the formulations in the present disclosure may comprise at least one polymerizable double bond or reactive group. The co-agent may provide additional crosslinks between the polyolefin chains of the polyolefin structural polymer. The co-agent may act to promote and enhance the efficiency of the crosslinking process. The co-agent may be selected from co-agents comprising reactive groups such as acrylates, allyl ethers, polybutadienes, vinyl ethers, and unsaturated vegetable oils, such as soybean oil. For example, the co-agent may be selected from acrylates, allyl ethers, polybutadienes and vinyl ethers. The co-agent may comprise a reactive carbon-carbon double bond. A reactive carbon-carbon double bond may be a carbon-carbon double bond that is a terminal carbon-carbon bond. The co-agent (or total amount of co-agents) may be present in an amount of 0.02 to 10% by weight. For example, the co-agent may be present in an amount of 0.1 to 5% by weight, 0.2 to 1% by weight, 0.3 to 0.7% by weight, e.g., about 0.5% by weight.

### Stabilizers

The cross-linkable feedstock composition according to the disclosure may optionally include a stabilizer. The stabilizer may be a UV stabilizer such as a hindered amine light stabilizer (HALS) or a hindered phenol stabilizer. The cross-linkable feedstock composition includes one or more hindered amine light stabilizers (HALS), e.g., to protect the cured composition from oxidation and degradation. Examples of hindered amine light stabilizers include Tinuvin 123 (Ciba), Tinuvin 622 (Ciba), Tinuvin 770 (Ciba), Cyasorb 3853 (Cytec), Cyasorb 3529 (Cytec) and Hostavin PR-31 (Clariant). A curable composition can include up to about 15% of one or more hindered amine light stabilizers. For example, the composition can include from about 0.1% to about 5%, or from about 0.1% to about 3% of the one or more hindered amine light stabilizers. In other embodiments, the curable composition is substantially free of a light stabilizer.

### Antioxidants

The cross-linkable feedstock composition according to the disclosure may optionally include an antioxidant. The antioxidant may be any appropriate antioxidant. The antioxidant may be a reactive antioxidant such as reactive hindered phenol 3-(3′,5′-di-tert.-butyl-4′-hydroxy phenyl) propyl-1-acrylate, DBPA; reactive hindered amine 4-acryloyloxyl 1,2,2,6,6-pentamethyl piperdine, AOPP; or reactive hindered amine 4-acryloyloxyl 1,2,2,6,6-tetramethyl piperdine, AOTP, for example, as synthesized in Al-Malaika S, Riasat S, Lewucha C, Reactive antioxidants for peroxide crosslinked polyethylene, Polymer Degradation and Stability (2017), doi: 10.1016/j.polymdegradstab.2017.04.013. The antioxidant may be present in about 0.1% to about 1%, or 0.25% to 0.75%, or about 0.5% by weight in the cross-linkable feedstock composition.

### Coextrusion

The systems and methods of making the PEX-a pipe according to the disclosure may optionally include co-extrusion of one or more additional layers to the PEX-a pipe. Methods and compositions for coating the pipe are known in the art, for example, as described in U.S. Pat. Nos. 9,937,527 and 9,656,298, each of which is incorporated herein by reference.

### Uses

The polymeric pipes prepared using the systems and methods of the disclosure comprises cross-linked polyethylene (PEX). The PEX-a pipes may be useful for drinking water pipe, plumbing, heating, and cooling; underfloor heating; wastewater; fire sprinkler systems and the like.

### Pipe Standards and Certifications

The disclosure provides systems and methods for making a PEX pipe that meets or exceeds one or more ASTM, NSF, or ISO standards.

Pipe standards and standard test procedures referenced in the present disclosure include the following: ASTM International Standard for Crosslinked Polyethylene (PEX) Tubing, ASTM F876-20a (Jan. 8, 2021) (“ASTM F876”); ASTM International Standard Specification for Crosslinked Polyethylene (PEX) Plastic Hot- and Cold-Water Distribution Systems, ASTM F877-00 (Aug. 16, 2017) (“ASTM F877”); ASTM International Standard Test Method for Evaluating the Oxidative Resistance of Crosslinked Polyethylene (PEX) Tubing and Systems to Hot Chlorinated Water, F2023-15 (Dec. 27, 2016) (“ASTM F2023”); ASTM International Standard Test Method for Oxidative-Induction Time of Polyolefins by Differential Scanning calorimetry, ASTM D3895-19 (Jun. 24, 2019) (“ASTM D3895”); NSF International Standard/American National Standard for Drinking Water Additives 61-2016 (Jan. 5, 2016) (“NSF 61”); and ISO Standard EN ISO 15875-Plastics piping systems for hot and cold water installations-Crosslinked polyethylene (PE-X). The contents of each of these standards are incorporated herein by reference.

The PEX tubing formed by the systems and methods according to the disclosure is capable of passing ASTM F876 and/or F877 test standards. The wall thickness of PEX tubing is based on Standard Dimension Ratio (SDR) 9. The pipes of the disclosure may be PEX pipes that meet or exceed temperature and pressure ratings requirements of 160 psi at 23° C. (73.4° F.), 100 psi at 82.2° C. (180° F.), and 80 psi at 93.3° C. (200° F.). Minimum burst ratings are 475 psi at 23° C. (73.4° F.) (⅝ inch and larger). PEX pipes of the disclosure may also meet additional performance characteristics and requirements set out in ASTM F 876-20b, which is incorporated by reference in its entirety.

ASTM F 876 is a standard specification for crosslinked polyethylene (PEX) tubing that is outside diameter controlled, made in standard thermoplastic tubing dimension ratios, and pressure rated for water at three temperatures. Included are requirements and test methods for material, workmanship, dimensions, sustained pressure, burst pressure, environmental stress cracking, stabilizer migration resistance, and degree of crosslinking. Methods of marking are also given.

The degree of crosslinking can be quantified in accordance with the following citation from ASTM F876: “6.8. Degree of Crosslinking-When tested in accordance with 7.9, the degree of crosslinking for PEX tubing material shall be within the range from 65 to 89% inclusive. Depending on the process used, the following minimum percentages crosslinking values shall be achieved: 70% by peroxides (PEX-a), 65% by Azo compounds, 65% by electron beam (PEX-c), or 65% by silane compounds (PEX-b)”. Ideally, pipes should have a high, i.e. at least 50% (preferably at least 65%), level of cross-linking according to the standard. However, in some applications a lower degree of cross-linking may be acceptable.

The present disclosure provides systems and methods for producing extruded pipes that consistently satisfy a defined target level of crosslinking (CCL) of, for example 72%, and may be maintained at that level at approximately 72±0.5% for a given formulation. In conventional prior art extrusion processes this variation may be least 3% and up to 5%, or more.

ASTM F877 specification covers requirements, test methods, and methods of making for cross-linked polyethylene plastic hot- and cold-water distribution systems components made in one standard dimension ration and intended for 100 psi (0.69 MPa) water service up to and including a maximum working temperature of 180 F (82° C.). Components are comprised of tubings and fittings. Requirements and test methods are included for materials, workmanship, dimensions and tolerances, hydrostatic sustained pressure strength, thermocycling resistance, fittings, and bend strength.

The systems and methods of the disclosure are able to produce PEX-a pipes that meet or exceed ASTM F877 standards including hot bending minimum radius of 2.5 times the outside diameter (O.D.), cold bending minimum radius of 6 times the outside diameter, and are able to sustain short term conditions of 48 h at 210° F., at 150 psi.

Chlorine resistance may be measured by ASTM F2023 and requires approximately 12-15 months of testing for completion.

A qualitative measure of the level of stabilization may be provided by the oxidative-induction time (OIT) test by differential scanning calorimetry (DSC), as performed in accordance with ASTM D3895.

Specific additives for pipes for drinking water applications may include comprise stabilizers, anti-oxidants, crosslinking agents, processing additives, etc. as part of the cross-linkable feedstock and in the final pipe composition. These additives may be added to provide pipes with desirable physical properties, e.g., pipes that satisfy ASTM F876 and/or EN ISO 15875 requirements. These chemical additives may be, however, typically subject to leaching from the final chemical pipe. Leaching of chemicals into the pipe is, however, undesirable. In addition, for certain applications there are limits set on levels of leached chemicals. For example, NSF 61 sets limits on chemical leaching for drinking water pipes. Drinking water pipes in North America must pass the NSF 61 test. The purpose of this test is to assure the customer that the quality of the water inside the pipe is not compromised by chemicals leaching into it. There are three ways to complete this test: 1) single point test, 2) 21-Day multipoint test and 3) 107-Day multipoint test. All three tests involve changing the water inside the pipe every 24 hours over an extended period of time. For the single point test only the water extract on Day 17 is tested. For the multipoint tests the water extracts on several days are analyzed and the resulting data is then used to create a decay curve. The water extracts may be analyzed by a Gas Chromatograph equipped with a Mass Spectrometer (GC/MS). If deemed necessary other analytical techniques are also used. Twenty-four hours prior to collecting a sample for analysis some of the samples are heated at 82° C. for 30 minutes. The heated extracts are then analyzed by GC/MS for semi-volatile compounds using EPA624 method. The rest of the samples are conditioned at room temperature and then analyzed by GC/MS for volatile compounds using EPA524 method.

To pass the multipoint tests the concentration of all chemicals extracted into the water must decay to below the Short Term Exposure Limit (STEL) on Day 17 and Total Allowable Concentration (TAC) on Day 107. For the single point test both the STEL and TAC limits must be met on Day 17. The allowance limits of NSF 61 were typically in the in the ppm range until recent years when the requirements have become more stringent, for example with the limits set in the ppb range for a number of compounds in current NSF standards.

The term “STEL” refers to the short term exposure limit. It typically represents the maximum concentration of a contaminant (e.g. a compound) that is permitted by a standard. For example, the NSF 61 standard specifies STEL values that represent the maximum concentration of a contaminant that is permitted in drinking water for an acute exposure calculated in accordance with the standard.

The term “TAC” refers to total allowable concentration. This is typically the maximum concentration of a contaminant (e.g. a compound) that a single product is allowed to contribute to a fluid. For example, the NSF 61 standard specifies TAC values that represent the maximum concentration of a contaminant in drinking water that a single product is allowed to contribute in accordance with the standard.

The principles, techniques, and features described herein can be applied in a variety of systems, and there is no requirement that all of the advantageous features identified be incorporated in an assembly, system or component to obtain some benefit according to the present disclosure.

From the forgoing detailed description, it will be evident that modifications and variations can be made without departing from the spirit and scope of the disclosure.

1. A system for preparing a cross-linked polyethylene a (PEX-a) pipe, the system comprising:
a heating device comprising a chamber having a central axis, an inlet, and an outlet; a plurality of oscillating infrared (IR) lamps; and a water-cooling apparatus for cooling the temperature in the chamber;
a controller comprising a program code for regulating oscillation of the IR lamp;
an extruder for conveying a cross-linkable feedstock into the chamber; and
a pipe head for forming the PEX-a pipe.

2. The system according to claim 1, wherein the central axis is a vertical axis.

3. The system according to claim 1, wherein the plurality of IR lamps are disposed at regular intervals around the chamber, optionally along the full length of the chamber.

4. The system according to claim 3, wherein the full length of the chamber is no more than 4 meters, no more than 3 meters, or no more than 2 meters in length.

5. The system according to claim 1, wherein the plurality of infrared lamps comprise 12 to 18 infrared lamps.

6. The system according to claim 1, wherein the chamber is capable of maintaining a temperature within a range of between 200° C. and 250° C.

7. The system according to claim 1, wherein the extruder comprises a heating module for melting the cross-linkable feedstock.

8. The system according to claim 1, further comprising a caterpillar for controlling the speed of the PEX-a pipe through the chamber; optionally wherein the caterpillar is adjacent to the outlet.

9. The system according to claim 1, further comprising a vacuum tank for setting the dimensions of the PEX-a pipe.

10. The system according to claim 1, further comprising a cooling bath for cooling the PEX-a pipe.

11. The system according to claim 1, further comprising a co-extruder for applying one or more additional layers to the cross-linked polyethylene a (PEX) pipe; optionally wherein the co-extruder is disposed between the vacuum tank and the cooling bath.

12. The system according to claim 1, wherein the cross-linkable feedstock comprises high-density polyethylene (HPDE) and an organic peroxide; optionally further comprising one or more additives selected from the group consisting of a stabilizer, plasticizer, and antioxidant; optionally wherein the feedstock is pre-blended.

13. A method of making a PEX-a pipe, comprising:
feeding a cross-linkable feedstock into the system according to claim 1 to form a cross-linkable pipe; and
exposing the cross-linkable pipe to the oscillating infrared lamps in the chamber to form the cross-linked polyethylene pipe.

14. The method according to claim 13, wherein the feeding comprises:
feeding the cross-linkable feedstock into the extruder;
melting the cross-linkable feedstock in the extruder; and
conveying the melted feedstock through the pipe head to form the cross-linkable pipe.

15. The method according to claim 13, further comprising setting the dimensions of the cross-linked polyethylene pipe in a vacuum tank.

16. The method according to claim 13, further comprising coextruding one or more layers on the cross-linked polyethylene pipe.

17. The method according to claim 15, further comprising cooling the cross-linked polyethylene pipe in a cooling bath.

18. The method according to claim 13, wherein the level of cross-linking of the PEX-a pipe is within a range of 70% to 90%, 70% to 80%, or at least 70% when tested according to ASTM F876.

19. The method according to claim 13, wherein the PEX-a pipe meets or exceeds chlorine resistance standard according to ASTM F2023.

20. The method according to claim 13, wherein the outer diameter (O.D.) of the PEX-a pipe is within +/−0.3 mm, within +/−0.2 mm, or within +/−0.1 mm when measured at a plurality of intervals along the pipe.

21. An assembly for forming piping, comprising:
a plurality of infrared ovens each configured to provide 360 degree heating, the infrared ovens being water cooled to provide complete circumferential cooling;
a driven master wheel positioned at a top side of the assembly directly adjacent to and outside of the plurality of infrared ovens;
a haul-off device downstream in close proximity to the driven master wheel, the haul-off device being positioned along a center point of the assembly to control stretching of the piping; and
a sensor to measure an outer diameter of the piping.
